(19) United States
(12) Patent Application Publication
(10) Pub. No.: US 2010/0111143 A1
(43) Pub. Date: May 6, 2010

(54) PORTABLE RADIO

(75) Inventors: Tomoaki Nishikido, Ishikawa (JP); Yutaka Saito, Ishikawa (JP); Yoshio Koyanagi, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/721,117

(22) PCT Filed: Dec. 5, 2005
(86) PCT No.: PCT/JP05/22294

§ 371 Date: Jun. 7, 2007

(30) Foreign Application Priority Data
Dec. 9, 2004 (JP) 2004-357318

(51) Int. Cl. H04L 5/16; H04K 1/10

(52) U.S. Cl. 375/219; 375/260

(57) ABSTRACT

A portable wireless unit capable of ensuring high speed, large capacity communication by lowering the correlation coefficient between antennas under various use states of a user. An antenna element (1) is arranged outside from the upper end of a case (4) on the side opposite to the display section (23) of the case, an antenna element (2) is arranged in parallel with and on the same side of the antenna element (1) while spaced apart in the width direction, and an antenna element (3) is arranged in parallel with the antenna element (1) from the display section (23) side spaced apart from the antenna element (1) in the thickness direction. The antenna element (1) is connected with a transmitter/receiver (14), and any one of the antenna element (2) or (3) is selected by controlling a high frequency switch (11) by angle information from a gravity sensor (22) and connected with the transmitter/receiver (14). A receiving signal is amplified by receiving circuits (18, 19) through the transmitter/receiver (14, 15) and then separated at a demodulating section (20) thus extracting reception information.

### TECHNICAL FIELD

The present invention relates to a portable radio exhibiting a low correlation in order to realize high-speed, high-capacity radio communication.

### BACKGROUND ART

In association with recent proliferation of mobile communication devices, construction of a high-speed, high-capacity radio communications system is required. Spatial multiplex transmission (MIMO: Multi-Input Multi-Output) by means of which communication is performed by use of a plurality of antennas disposed on a transmission side and a plurality of antennas disposed on a receiving side has gained attention as a technique for realizing the high-speed, high-capacity radio communications system.

Spatial multiplexing is performed by means of transmitting a single space-time-encoded signal from a plurality of transmission antennas within a single band. The signals are received by a plurality of receiving antennas, and the thus-received signals are separated, to thus extract information. As a result, a transfer rate is improved, and high-capacity communication becomes feasible. Consequently, in relation to a future portable radio communications system such as a fourth-generation portable radio communications system, application of the MIMO technique is expected, and realizing the future portable radio communications system requires an antenna configuration for a portable radio appropriate for MIMO.

In order to separate the spatially-multiplexed signals at the receiving side, the antennas must be arranged such that fading correlation among the antennas becomes sufficiently small. Moreover, in view of the nature of the portable radio, it is important to reduce a correlation coefficient among a plurality of antennas attached to a portable cellular phone when a user is operating the portable cellular phone.

In connection with a related-art portable radio addressing such a problem, a configuration such as that described in, e.g., Patent Document 1, has hitherto been known. Namely, antennas are provided in each of an upper housing and a lower housing of a collapsible portable cellular phone, and low correlation among the antennas is attained.

Moreover, as described in Patent Document 2, there has been known a configuration of a telescopic whip antenna and a built-in helical antenna being provided in an upper portion of a housing of the portable cellular phone, thereby implementing diversity.

Patent Document 1: JP-A-3-280625

Patent Document 2: JP-A-9-135120

### DISCLOSURE OF THE INVENTION

### Problem that the Invention is to Solve

However, in the above-described, related-art antennas described in Patent Document 1, since the antennas are provided in the lower housing, a hand covers the antenna section when the user uses the portable cellular phone, thereby significantly deteriorating an antenna gain. Thus, the conventional antennas pose a problem of degradation of performance of high-speed, high-capacity communication and another problem of a failure to disclose a circuit configuration of a radio section taking into consideration high-speed, high-capacity transmission.

In the related-art antennas described in Patent Document 2, since a location where antennas are disposed is limited, a correlation coefficient among the antennas is increased when the portable cellular phone is used at an inclination. Hence, the related-art antennas pose a problem of degradation of performance of high-speed, high-capacity communication and another problem of a failure to disclose a circuit configuration of a radio section taking into consideration high-speed, high-capacity transmission.

The present invention has been conceived in light of the circumstances and aims at providing a portable radio in which two antennas are arranged in a widthwise direction of the portable cellular phone and one antenna is arranged in a thickness direction of the same so as to oppose one of the two antennas, thereby reducing a correlation coefficient among antennas in various situations where the user uses a portable cellular phone and assuring high-seed, high-capacity communication.

### Means for Solving the Problem

In order to achieve the object, a portable radio of the present invention corresponds to a portable radio comprising:

a first antenna element and a second antenna element which are placed in parallel and separately from each other in a thickness direction of a housing;

a third antenna element placed in parallel and separately from the first antenna element in a widthwise direction of the housing;

a first duplexer connected to the first antenna element;

selection means for selecting either the second antenna element or the third antenna element and connecting the selected antenna element to a second duplexer;

control means for controlling the selection means such that correlation between the first antenna element and the second or third antenna element becomes smaller;

a circuit board which is placed in the housing and has a ground pattern;

a first radio circuit section which is mounted on the circuit board and connected to the first duplexer; and

a second radio circuit section which is mounted on the circuit board and connected to the selection means.

According to such a configuration, there can be achieved a reduction in a correlation coefficient between antennas in various situations where a user uses the portable radio and implementation of high-speed, high-capacity communication.

Moreover, a portable radio of the present invention corresponds to a portable radio comprising:

a first housing;

a first plate conductor placed in the first housing along a long side thereof;

a second plate conductor and a third plate conductor which are placed in the first housing separately from the first plate conductor and along the long side of the housing;

a second housing;

a hinge section for pivotably joining the first housing and the second housing together;

a circuit board which is placed in the second housing and has a ground pattern;

a selection unit for selecting any one from a combination of the first plate conductor and the second plate conductor, a combination of the first plate conductor and the third plate conductor, and a combination of the second plate conductor and the third plate conductor;

a control unit for controlling the selection unit such that correlation between plate conductors of the selected combination becomes smaller;

a plurality of duplexers connected to the plate conductors of the selected combination; and

a radio circuit section which is mounted on the circuit board and connected to one of the duplexers.

According to such a configuration, a built-in antenna can be configured within a range where the design of the portable radio is not impaired. There can be achieved a reduction in a correlation coefficient between antennas in various situations where a user uses the portable radio and implementation of high-speed, high-capacity communication.

Further, the portable radio of the present invention further adopts a configuration comprising an inclination detection unit for detecting an angle of inclination of the portable radio as the control unit for controlling the selection means, and the selection unit is controlled in accordance with a result of detection performed by the inclination detection unit.

According to such a configuration, there can be achieved a reduction in a correlation coefficient between antennas in various situations where a user uses the portable radio and implementation of high-speed, high-capacity communication.

Further, the portable radio of the present invention further adopts a configuration in which a radiating element which is not selected by the selection unit is short-circuited to the circuit board by way of a circuit having a certain, specific reactance component.

According to such a configuration, there can be achieved a reduction in a correlation coefficient between antennas in various situations where a user uses the portable radio and implementation of high-speed, high-capacity communication.

### Advantage of the Invention

According to the portable radio of the present invention, there can be provided a portable radio yielding an advantage of the ability to reduce a correlation coefficient among antennas in various situations where the user uses a portable radio and assure high-speed, high-capacity communication by means of arranging two antennas in a widthwise direction of the portable radio and arranging one antenna in a thickness direction of the same so as to oppose one of the two antennas.

### BRIEF DESCRIPTION OF THE DRAWINGS

FIG. 1 is a basic schematic diagram showing a portable radio of a first embodiment of the present invention;

FIG. 2 is a view for describing the inclination of the portable radio;

FIG. 3 is a view showing the state of telephone conversation of the portable radio;

FIG. 4 is a view for describing the inclination of the portable radio;

FIG. 5 is a view showing an operating state of the portable radio; and

FIG. 6 is a basic schematic diagram showing a portable radio of a second embodiment of the present invention, wherein 6A is a general schematic diagram of the portable radio when viewed from back and 6B is a cross-sectional view of the portable radio taken along line A-A shown in 6A.

### DESCRIPTIONS OF THE REFERENCE NUMERALS AND SIGNS

1, 2, 3 antenna elements

4 housing

5, 6, 7, 33, 34, 35 feeding points

8, 9, 10, 39, 40, 41 matching circuits

11, 42 high-frequency switches

12, 13, 43, 44, 45 terminator circuits

14, 15 duplexers

16, 17 transmission circuits

18, 19 receiving circuits

20 demodulation section

21 control section

22 gravity sensor

23, 49 display section

24, 46 ground plates

30, 31, 32 plate conductors

36, 37, 38 feeder lines

50 upper case

51 lower case

52 hinge section

### BEST MODES FOR CARRYING OUT THE INVENTION

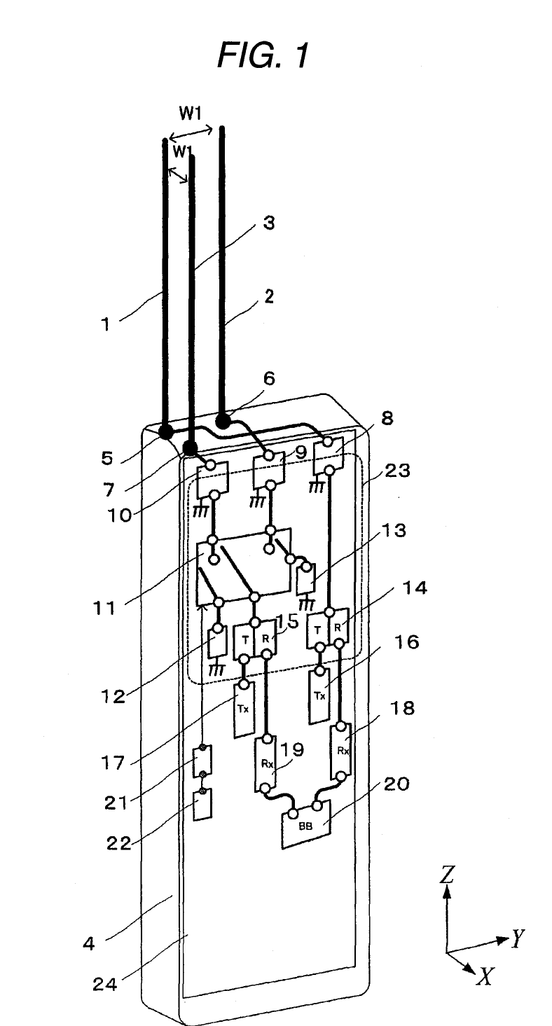

Portable radios of embodiments of the present invention will be described hereinbelow by reference to FIGS. 1 through 6 and Mathematical Expression (1).

### First Embodiment

First, a portable radio of a first embodiment of the present invention will be described by reference to FIGS. 1 through 5.

FIG. 1 shows a basic schematic diagram showing a portable radio of a first embodiment of the present invention. As shown in FIG. 1, a housing 4 of the portable radio of the present embodiment is molded from a resin material corresponding to an insulator. In general, the housing is set to a length of 120 mm, a width of 50 mm, and a depth of 15 mm, or thereabouts. A conductive antenna element 1 is made of a copper line having, e.g. a length of 70 mm and a diameter of 1 mm. The conductive antenna element 1 is disposed, in the same direction as the longitudinal direction of the housing 4 (i.e., a direction perpendicular to the upper surface of the upper portion of the housing) toward the outside, at a corner of an upper portion on the side of the housing opposing a display section 23.

A conductive antenna element 2 is made of a copper line having, e.g. a length of 70 mm and a diameter of 1 mm. The conductive antenna element 2 is disposed at a position on the side of the housing opposing the display section 23 in parallel to the antenna element 1 while a space W1 between the antenna element 1 and the antenna element 2 is set to, e.g., 12 mm.

A conductive antenna element 3 is made of a copper line having, e.g. a length of 70 mm and a diameter of 1 mm. The conductive antenna element 3 is disposed at the corner on the side of the housing opposing the display section 23 in parallel to the antenna element 1 while a space W1 between the antenna element 1 and the antenna element 3 is set to, e.g., 12 mm.

A feeding point 5 provided in a lower portion of the antenna element 1 is electrically connected to a matching circuit 8 provided in the housing 4; a feeding point 6 provided in a lower portion of the antenna element 2 is electrically connected to a matching circuit 9 provided in the housing 4; and a feeding point 7 provided in a lower portion of the antenna element 3 is electrically connected to a matching circuit 10 provided in the housing 4. The ground potential of the matching circuit 8, that of the matching circuit 9, and that of the matching circuit 10 are connected to a ground pattern routed on a ground plate 24. The matching circuit 8 performs the function of matching the impedance of the antenna element 1 to a circuit impedance (generally assuming a value of 50Ω); the matching circuit 9 performs the function of matching the impedance of the antenna element 2 to the circuit impedance; and the matching circuit 10 performs the function of matching the impedance of the antenna element 3 to the circuit impedance.

A single time-space-encoded signal is amplified by transmission circuits 16 and 17, each of which serves as a radio circuit section. The transmission circuit 16 feeds power to the matching circuit 8 by way of a duplexer 14 which is intended for using a single antenna for transmission and receiving operations. The transmission circuit 17 feeds power to the matching circuit 9 or the matching circuit 10 by way of a duplexer 15 and a high-frequency switch 11.

The high-frequency switch 11 is formed from, e.g., an FET or a PIN diode, and makes a selection as to whether to feed power to the matching circuit 9 or the matching circuit 10 by means of a control signal from a control section 21. Of the matching circuits 9 and 10, any one matching circuit which is not supplied with power is connected to a terminator circuit 12 or a terminator circuit 13. Each of the terminator circuit 12 and the terminator circuit 13 has given impedance; is constituted of a specific reactance element or a resistor; and is earthed to the ground pattern routed on the ground plate 24. The control section 21 generates a signal for controlling the high-frequency switch 11 in accordance with angular information from a gravity sensor 22 that detects the angle of inclination of the housing 4 of the portable radio. The gravity sensor 22 is formed from, e.g., a gyroscopic sensor, and detects the inclination of the portable radio.

A received signal is amplified by receiving circuits 18 and 19, each of which serves as a radio circuit section, by way of the duplexers 14 and 15, and separated by a demodulation section 20, whereby received information is extracted.

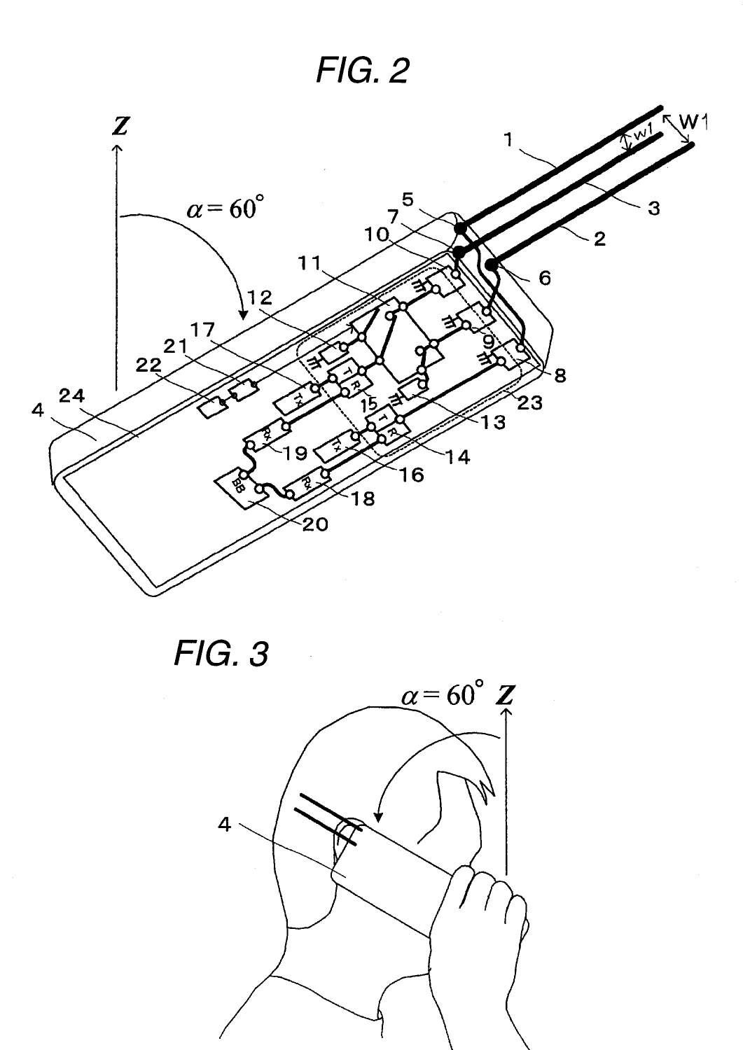

Operation of the antenna of the thus-configured portable radio will be described on the assumption that an operation frequency is set to, e.g., 2.14 GHz, in consideration of the operating state of the portable radio such as that shown in FIGS. 2 through 5.

In order to materialize high-speed, high-capacity communication, correction among the antennas must be reduced. Moreover, correlation between antennas is usually used as an index which is used for evaluating correlation between antennas of a portable radio. A theoretical expression (1) of a correlation coefficient (ρe) of two antennas is described in an academic journal of The Institute of Electronics, Information and Communication Engineers (B-II, Vol. J73-B-II, No. 12, pp. 883 to 895). For instance, in the case illustrated in FIG. 1, the correlation coefficient is given by Theoretical Expression (1) provided below, in a state where the tip ends of the antennas of the portable radio are oriented toward the direction of the Zenith (Z).

$$\begin{matrix}[ Mathematical Expression 1 ] & \\ {ρ}_{e} = \frac{{\vert {\int }_{0}^{2 π} {\int }_{0}^{π} [ XPR \cdot {E}_{θ1} \cdot {E}_{θ2}^{*} \cdot {P}_{θ} + {E}_{φ1} \cdot {E}_{φ2}^{*} \cdot {P}_{φ} ] d Ω \vert}^{2}}{\begin{matrix}{\int }_{0}^{2 π} {\int }_{0}^{π} [ XPR \cdot {E}_{θ1} \cdot {E}_{θ1}^{*} \cdot {P}_{θ} + {E}_{φ1} \cdot {E}_{φ1}^{*} \cdot {P}_{φ} ] d Ω \times \\ {\int }_{0}^{2 π} {\int }_{0}^{π} [ XPR \cdot {E}_{θ2} \cdot {E}_{θ2}^{*} \cdot {P}_{θ} + {E}_{φ2} \cdot {E}_{φ2}^{*} \cdot {P}_{φ} ] d Ω\end{matrix}} & ( 1 )\end{matrix}$$

In Mathematical Expression (1), Eθ1 , Eφ1 designate complex field directivities of a θ-polarization component of the antenna 1; and Eθ2, Eφ2 designate complex field directivities of a θ-polarization component of the antenna 2. Pθ(θ,φ) designates an incoming-wave angle density function of a θ component entering the antenna, and Pφ(θ,φ) designates an incoming-wave angle density function of a φ component entering the antenna.

XPR designates a transverse power ratio of the incoming wave entering the antenna, which is a power ratio of a vertical polarization component to a horizontal polarization component. The general transverse power ratio XPR in the multiwave environment of mobile communication is known to range from 4 dB to 9 dB. The reason for this is that the transverse power ratio of computed on the assumption that the vertical polarization component of the incoming wave is higher than the horizontal polarization component of the same by 4 dB to 9 dB. Consequently, in a radiating pattern of the antenna, the vertical polarization component is weighted by an amount corresponding to XPR.

Subsequent descriptions are provided by use of an XPR value of 6 dB, which is common in an urban area. An average elevation angle of the incoming wave in the urban area is known to be present within an essentially-horizontal range from 0° to 30°. Hence, herein subsequent descriptions are provided by use of a computation result acquired by setting an average elevation angle 0° and a standard deviation showing the spread of the incoming wave to 20°. A correlation coefficient usually desirably assumes a value of 0.6 or less.

First will be described a case where the portable radio is arranged such that the tip ends of the antenna element 1, the antenna element 2, and the antenna element 3 of the portable radio—which are on the side opposite the feeding point 5, the feeding point 6, and the feeding point 7—are directed in the direction of the Zenith (Z) as shown in FIG. 1. The space W1 between the antenna element 1 and the antenna element 2 is 12 mm, and a correlation coefficient achieved in this case is 0.55. The space W1 between the antenna element 1 and the antenna element 3 is 12 mm. A correction efficient achieved in this case comes to a value identical with 0.55. Therefore, in this case, the high-frequency switch 11 may select either the antenna element 2 or the antenna element 3. Herein, for instance, the antenna element 2 is assumed to be selected. Moreover, each of the antenna element 1, the antenna element 2, and the antenna element 3 has a length of 70 mm and operates as a half-wavelength monopole antenna. The directivity of a vertical polarization component achieved in a horizontal plane becomes essentially non-directional.

The angle of inclination is determined to be 0° from the result of detection performed by the gravity sensor 22 that detects the angle of inclination of the portable radio. The detection result is sent to the control section 21, and the control section 21 sends a control signal to the high-frequency switch 11 such that the duplexer 15 is connected to the matching circuit 9 of the antenna element 2 and such that the terminator circuit 12 is connected to the matching circuit 10 of the antenna element 3. In this case, the impedance of the terminator circuit 12 is set to 50Ω, whereby low correlation is achieved.

As a result of switching of the high-frequency switch 11 as mentioned above, the correlation coefficient between the antenna element 1 and the antenna element 2 is suppressed to a low value of 0.55. In the case of transmission, single time-space-encoded signals are transmitted at a single band from the antenna element 1 and the antenna element 2, thereby effecting spatial multiplexing. Likewise, even in the case of receiving operation, the antenna element 1 and the antenna element 2 receive the signals and separate the thus-received signals, thereby extracting information. As a result, a transfer rate is improved, and high-capacity communication becomes feasible.

When the portable radio is inclined as shown in FIG. 2 (i.e., when the portable radio is inclined by 60° from the Z axis toward a Y direction within the coordinate system shown in FIG. 1), a correlation coefficient between the antenna element 1 and the antenna element 2 comes to a high 0.75, and the effect of high-speed, high-capacity communication is diminished. The reason for this is that, when the portable radio is inclined, a radio wave is assumed to arrive from an essentially-horizontal direction (along an X-Y plane) and, hence, the position of the antenna element 1 and the position of the antenna element 2 are deemed to be identical with each other when viewed from a distant field in the direction of maximum gain (i.e., an X direction) of the antenna element 1 and the direction of maximum gain of the antenna element 2. In short, spatial, positional differences (phase differences) of the antenna elements are substantially equal to each other, so that correlation becomes higher.

In contrast, the correlation coefficient between the antenna element 1 and the antenna element 3 comes to 0.54, thus exhibiting low correlation. The reason for this is that, when the portable radio is inclined, a radio wave is assumed to arrive from an essentially-horizontal direction (along the X-Y plane) and, hence, the position of the antenna element 1 and the position of the antenna element 3 are deemed to differ from each other when viewed from a distant field in the direction of maximum gain (i.e., the X direction) of the antenna element 1 and the direction of maximum gain of the antenna element 3. In short, spatial, positional differences (phase differences) of the antenna elements are deemed to differ from each other, whereby correlation can be suppressed to a low level.

Therefore, in this case, the gravity sensor 22 for detecting the angle of inclination of the portable radio detects that the portable radio is inclined in the Y direction, and sends a result of detection to the control section 21. The control section 21 sends a control signal to the high-frequency switch 11 such that the duplexer 15 is connected to the matching circuit 10 of the antenna element 3 and such that the terminator circuit 13 is connected to the matching circuit 9 of the antenna element 2. In this case, for instance, the impedance of the terminator circuit 13 is set to a value of 50Ω, whereby low correlation is attained.

As a result of switching of the high-frequency switch 11 as mentioned above, the correlation coefficient between the antenna element 1 and the antenna element 3 is suppressed to a low value of 0.54. In the case of transmission, single time-space-encoded signals are transmitted at a single band from the antenna element 1 and the antenna element 3, thereby effecting spatial multiplexing. Likewise, even in the case of receiving operation, the antenna element 1 and the antenna element 3 receive the signals and separate the thus-received signals, thereby extracting information. Thus, a transfer rate is improved, and high-capacity communication becomes feasible.

As shown in, e.g., FIG. 3, the inclination of the portable radio is essentially equal to an angle achieved during conversation in which the user uses the portable radio while holding it in the hand and close to an ear. Specifically, the angle of inclination of the portable radio is detected even in the state of conversation, and the antenna element 1 and the antenna element 3 are selected, so that low correction is achieved between the antennas. Therefore, a transfer rate is increased, and high-capacity communication becomes feasible.

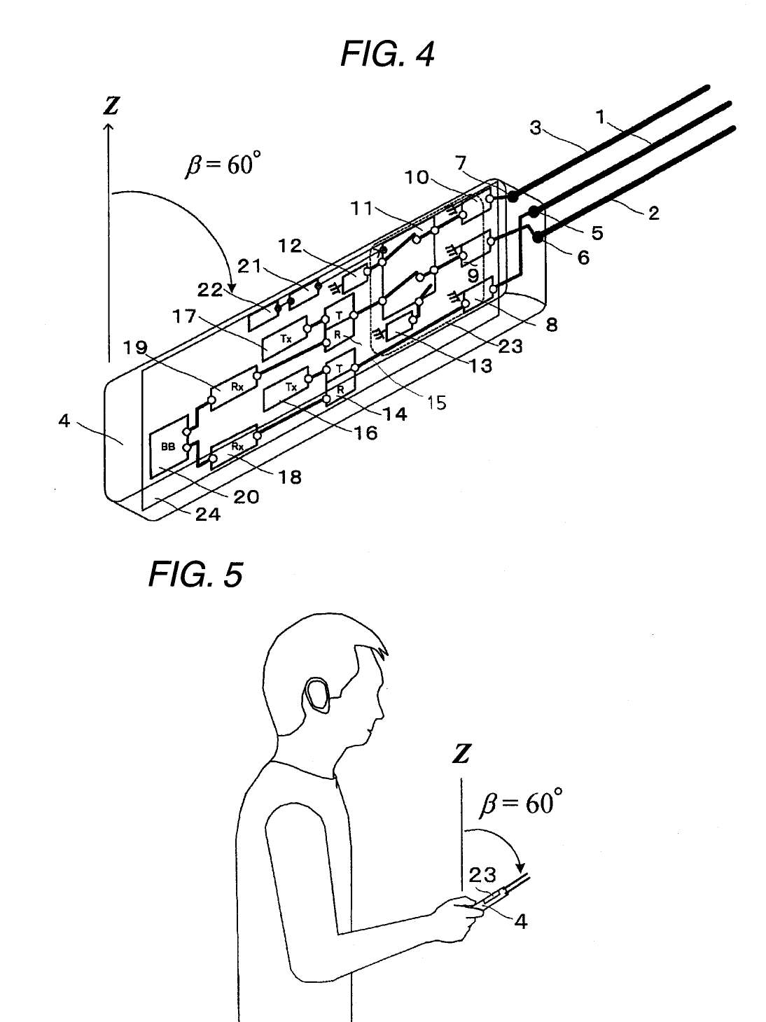

When the portable radio is inclined as shown in FIG. 4 (i.e., when the portable radio is inclined by 60° from the Z axis toward a −X direction within the coordinate system shown in FIG. 1), a correlation coefficient between the antenna element 1 and the antenna element 3 comes to a high value of 0.84, and the effect of high-speed, high-capacity communication is diminished. The reason for this is that, when the portable radio is inclined, a radio wave is assumed to arrive from the essentially-horizontal direction (along the X-Y plane) and, hence, the position of the antenna element 1 and the position of the antenna element 3 are deemed to be identical with each other when viewed from the distant field in the direction of maximum gain (i.e., the Y direction) of the antenna element 1 and the direction of maximum gain of the antenna element 3. In short, spatial, positional differences (phase differences) of the antenna elements are substantially equal to each other, so that correlation becomes higher.

In contrast, the correlation coefficient between the antenna element 1 and the antenna element 2 comes to a low value of 0.49, thus exhibiting low correlation. The reason for this is that, when the portable radio is inclined, a radio wave is assumed to arrive from the essentially-horizontal direction (along the X-Y plane) and, hence, the position of the antenna element 1 and the position of the antenna element 2 are deemed to differ from each other when viewed from a distant field in the direction of maximum gain (i.e., the Y direction) of the antenna element 1 and the direction of maximum gain of the antenna element 2. In short, spatial, positional differences (phase differences) of the antenna elements are deemed to differ from each other, whereby correlation can be suppressed to a low level.

Therefore, in this case, the gravity sensor 22 for detecting the angle of inclination of the portable radio detects that the portable radio is inclined in the −X direction, and sends a result of detection to the control section 21. The control section 21 sends a control signal to the high-frequency switch 11 such that the duplexer 15 is connected to the matching circuit 9 of the antenna element 2 and such that the terminator circuit 12 is connected to the matching circuit 10 of the antenna element 3. In this case, for instance, the impedance of the terminator circuit 12 is set to a value of 50Ω, whereby low correlation is attained.

As a result of switching of the high-frequency switch 11 as mentioned above, the correlation coefficient between the antenna element 1 and the antenna element 2 is suppressed to a low value of 0.49. In the case of transmission, single time-space-encoded signals are transmitted at a single band from the antenna element 1 and the antenna element 2, thereby effecting spatial multiplexing. Likewise, even in the case of receiving operation, the antenna element 1 and the antenna element 2 receive the signals and separate the thus-received signals, thereby extracting information. As a result, a transfer rate is improved, and high-capacity communication becomes feasible.

As shown in, e.g., FIG. 5, the inclination of the portable radio is essentially equal to an angle achieved in an operating state where the user performs operation for creating a mail, making a connection with the Internet, or using a TV telephone while holding it in the hand at a position before the user's breast. Specifically, the angle of inclination of the portable radio is detected in the operating state, and the antenna element 1 and the antenna element 2 are selected, so that low correction is achieved between the antennas. Therefore, a transfer rate is increased, and high-capacity communication becomes feasible.

As described above, the characteristic of the portable radio of the present embodiment lies in that two antennas are arranged in the widthwise direction of the portable radio; that one antenna is arranged in the thickness direction of the portable radio so as to face one of the two antennas; and that antenna elements are selected in various situations where the user uses a portable cellular phone, thereby reducing a correlation coefficient between the antennas and ensuring high-speed, high-capacity communication.

The present embodiment has described the antennas disposed on the upper portion of the housing as three half-wavelength monopole antennas. However, the antennas are not limited to these. Even when a quarter-wave monopole antenna element or a helical element is used, low correlation is achieved. Thus, low correlation can be realized by arrangement conditions.

Further, the present embodiment has described the antennas placed on the upper portion of the housing as three half-wave monopole antennas. However, the antennas are not limited to these. Low correlation is achieved even when two inverted-F plate antennas are disposed in a direction opposite the surface of the display section and when one inverted-F plate antenna is disposed on the display section opposite one of the two antennas. Moreover, antenna elements can be incorporated into the housing.

The present embodiment has shown the structure of a straight-type portable radio which is not divided into an upper housing and a lower housing. However, even in the case of a collapsible portable radio divided into an upper housing and a lower housing, a similar advantage is yielded, so long as three antenna elements are arranged on the upper housing in the same manner. The same advantage is yielded even when three antenna elements are arranged in a hinge section in the same manner.

In the present embodiment, when the number of antenna elements and the number of transceiving circuits are further increased, the effect of high-speed, high-capacity communication can be enhanced to a much greater extent.

### Second Embodiment

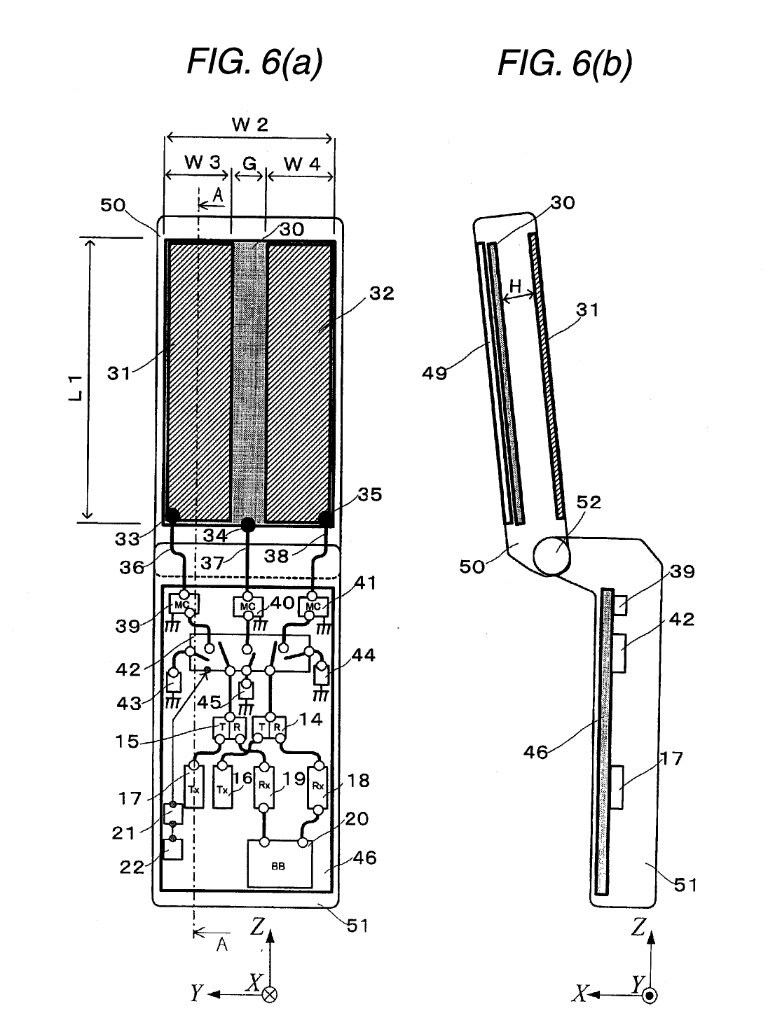

A portable radio of a second embodiment of the present invention will now be described by reference to FIG. 6.

FIG. 6 is a basic schematic diagram showing a portable radio of a second embodiment of the present invention, wherein 6A is a general schematic diagram of the portable radio when viewed from back and 6B is a cross-sectional view of the portable radio taken along line A-A shown in 6A.

In FIG. 6, those reference numerals identical with those shown in FIG. 1 designate the same constituent elements, which are assumed to operate in the same manner.

FIG. 6 shows that a portable radio having a collapsible structure is opened (hereinafter called an “open state”).

The portable radio has an upper case 50, a lower case 51, a hinge section 52, a plate conductor 30, a plate conductor 31, a plate conductor 32, a ground plate 46, and a display section 49.

The upper case 50 corresponding to an upper housing and the lower case 51 corresponding to a lower housing are formed from a resin which is an insulator, and are usually set to a length of about 100 mm and a width of about 50 mm. The upper case 50 and the lower case 51 are connected together so as to be pivotable at the hinge section 52, thereby constituting a collapsible structure.

The plate conductor 30 corresponding to a plate antenna element is made of a copper plate having, e.g., a length L1 of about 70 mm and a width W2 of about 45 mm. The plate conductor 30 is disposed in the upper case 50 along the surface of a display section 49 of the upper case. The plate conductor 31 is made of a copper plate having, e.g., a length L1 of about 70 mm and a width W3 of about 20 mm; and the plate conductor 32 is made of a copper plate having, e.g., a length L1 of about 70 mm and a width W4 of about 20 mm. The plate conductors 31 and 32 are disposed within the upper case 50 along a surface opposite the surface of the display section 49 of the upper case.

A space G between the plate conductors 31 and 32 is set to, e.g., 5 mm, and a space H among the plate conductor 31, the plate conductor 32, and the plate conductor 30 is set to, e.g., 5 mm. The thickness of each of the plate conductors 30, 31, and 32 is set to, e.g., 0.1 mm or thereabouts. The plate conductors 30, 31, and 32 are disposed within the low-profile upper case 50 whose thickness of the order of about 7 mm, so as not to structurally interfere with other constituent components such as a display element.

The ground plate 46 is a conductor plate having, e.g., a length of about 90 mm and a width of about 45 mm. In general, a ground pattern of a circuit placed in the lower case 51 is utilized as the ground plate. A ground pattern brought into a ground potential of circuitry is formed over substantially the entire surface of the ground plate 46. The ground potential of a matching circuit 39, that of a matching circuit 40, and that of a matching circuit 41 are earthed to the ground pattern of the ground plate 46.

A feeding point 33 provided in a lower portion of the plate conductor 30 is electrically connected to the matching circuit 39 by means of a feeder line 36; a feeding point 34 provided in a lower portion of the plate conductor 31 is electrically connected to the matching circuit 40 by means of a feeder line 37; and a feeding point 35 provided in a lower portion of the plate conductor 32 is electrically connected to the matching circuit 41 by means of a feeder line 38.

A flexible wire which can be bent freely is used for the feeder lines 36, 37, and 38, so that the upper case 50 can pivot at the hinge section 52 with respect to the lower case 51.

The matching circuit 39 performs the function of matching the impedance of the plate conductor 30 to a circuit impedance (generally assuming a value of 50Ω); the matching circuit 40 performs the function of matching the impedance of the plate conductor 31 to the circuit impedance; and the matching circuit 41 performs the function of matching the impedance of the plate conductor 32 to the circuit impedance.

A single time-space-encoded signal is amplified by the transmission circuits 16 and 17. The transmission circuit 16 feeds power to the matching circuit 40 or 41 by way of the duplexer 14 and the high-frequency switch 42. The transmission circuit 17 feeds power to the matching circuit 39 or 40 by way of the duplexer 15 and the high-frequency switch 42. Further, for instance, when the duplexer 14 is connected to the matching circuit 40, the duplexer 15 is not connected to the matching circuit 40 but is connected to the matching circuit 39. Namely, the high-frequency switch 42 is controlled so as to prevent the matching circuit 40 from being simultaneously connected to the duplexers 14 and 15.

The high-frequency switch 42 is formed from, e.g., an FET or a PIN diode; and makes a selection, by means of the control signal from the control section 21, as to whether to feed power to any one of combinations; i.e., a combination of the matching circuit 39 and the matching circuit 40; a combination of the matching circuit 40 and the matching circuit 41; and a combination of the matching circuit 39 and the matching circuit 41. Of the matching circuits 39, 40, and 41, any one matching circuit which is not supplied with power is connected to a terminator circuit 43, a terminator circuit 44, or a terminator circuit 45. Each of the terminator circuits 43, 44, and 45 has given impedance; is constituted of a specific reactance element or a resistor; and is earthed to the ground pattern routed on the ground plate 46.

With such a configuration, the plate conductors 30, 31, and 32 operate as dipole antennas supplied with power from the ground plate 46.

Operation of the antenna of the thus-configured portable radio will be described on the assumption that an operation frequency is set to, e.g., 2.14 GHz, in consideration of the operating state of the portable radio such as that shown in FIGS. 2 through 5.

First will be described a case where the portable radio is arranged such that the tip ends of the plate conductors 30, 31, and 32 of the portable radio—which are on the side opposite to their feeding points—are directed in the direction of the Zenith (Z) as shown in FIG. 6.

The space H between the plate conductors 30, 31, and 32 is 5 mm, and a correlation coefficient achieved in this case is 0.15. The space G between the plate conductors 31 and 32 is also 5 mm, but a correction efficient achieved in this case comes to 0.27, which is increased by about 0.1. Therefore, in this case, either one of the combination of the plate conductors 30 and 31 and the combination of the plate conductors 30 and 32 may also be selected. Herein, for instance, the combination of the plate conductors 30 and 31 is assumed to be selected.

The angle of inclination is determined to be 0° from the result of detection performed by the gravity sensor 22 that detects the angle of inclination of the portable radio. The detection result is sent to the control section 21, and the control section 21 sends a control signal to the high-frequency switch 42 such that the duplexer 15 is connected to the matching circuit 39 of the plate conductor 31; such that the duplexer 14 is connected to the matching circuit 40 of the plate conductor 30; and such that the terminator circuit 44 is connected to the matching circuit 41 of the plate conductor 32. In this case, the impedance of the terminator circuit 41 is set to 50Ω.

As a result of switching of the high-frequency switch 42 as mentioned above, the correlation coefficient between the plate conductors 30 and 31 is suppressed to a low 0.15. In the case of transmission, single time-space-encoded signals are transmitted at a single band from the plate conductors 30 and 31, thereby effecting spatial multiplexing. Likewise, even in the case of receiving operation, the plate conductors 30 and 31 receive the signals and separate the thus-received signals, thereby extracting information. As a result, a transfer rate is improved, and high-capacity communication becomes feasible.

Next, in relation to the configuration shown in FIG. 6, when the portable radio is inclined as shown in FIG. 2 (i.e., when the portable radio is inclined by 60° from the Z axis toward the Y direction within the coordinate system shown in FIG. 6), a correlation coefficient between the conductor plate 31 and the conductor plate 32 comes to a high value of 0.40, and the effect of high-speed, high-capacity communication is diminished as compared with the case where the portable radio is not inclined. The reason for this is that, when the portable radio is inclined, a radio wave is assumed to arrive from an essentially-horizontal direction (along the X-Y plane) and, hence, the position of the plate conductor 31 and the position of the plate conductor 32 are deemed to be identical with each other when viewed from a distant field in the direction of maximum gain (i.e., the X direction) of the plate conductor 31 and the direction of maximum gain of the plate conductor 32. In short, spatial, positional differences (phase differences) of the antenna elements are substantially equal to each other, so that correlation becomes higher.

In contrast, the correlation coefficient between the plate conductor 30 and the plate conductor 31 and the correlation coefficient between the plate conductor 30 and the plate conductor 32 come to 0.15, thus exhibiting low correlation. The reason for this is that, when the portable radio is inclined, a radio wave is assumed to arrive from an essentially-horizontal direction (along the X-Y plane) and, hence, the positional relationship between the conductor plate 30 and the plate conductor 31 and the positional relationship between the conductor plate 30 and the plate conductor 32 are deemed to differ from each other when viewed from the distant field in the direction of maximum gain (i.e., the X direction) of the conductor plate 30 and the direction of maximum gain of the conductor plate 31 as well as in the direction of maximum gain of the conductor plate 30 and the direction of maximum gain of the conductor plate 32. In short, spatial, positional differences (phase differences) of the conductor plates are deemed to differ from each other, whereby correlation can be suppressed to a low level.

Therefore, in this case, either one of the combination of the plate conductors 30 and 31 and the combination of the plate conductors 30 and 32 may also be selected. Herein, for instance, the combination of the plate conductors 30 and 32 is assumed to be selected.

As a result of switching of the high-frequency switch 42 as mentioned above, the correlation coefficient between the plate conductors 30 and 32 is suppressed to a low value of 0.15. In the case of transmission, single time-space-encoded signals are transmitted at a single band from the plate conductors 30 and 32, thereby effecting spatial multiplexing. Likewise, even in the case of receiving operation, the plate conductors 30 and 32 receive the signals and separate the thus-received signals, thereby extracting information. As a result, a transfer rate is improved, and high-capacity communication becomes feasible.

Therefore, in this case, the gravity sensor 22 for detecting the angle of inclination of the portable radio detects that the portable radio is inclined in the Y direction, and sends a result of detection to the control section 21. The control section 21 sends a control signal to the high-frequency switch 42 such that the duplexer 15 is connected to the matching circuit 40 of the plate conductor 30; such that the duplexer 14 is connected to the matching circuit 41 of the plate conductor 32; and such that the terminator circuit 43 is connected to the matching circuit 39 of the plate conductor 31. In this case, for instance, the impedance of the terminator circuit 43 is set to a value of 50Ω.

As a result of switching of the high-frequency switch 42 as mentioned above, the correlation coefficient between the plate conductors 30 and 32 is suppressed to a low value of 0.15. In the case of transmission, single time-space-encoded signals are transmitted at a single band from the plate conductors 30 and 32, thereby effecting spatial multiplexing. Likewise, even in the case of receiving operation, the plate conductors 30 and 32 receive the signals and separate the thus-received signals, thereby extracting information. As a result, a transfer rate is improved, and high-capacity communication becomes feasible.

As shown in, e.g., FIG. 3, the inclination of the portable radio is essentially equal to an angle achieved in a state of conversation where the user uses the portable radio while holding it in the hand and close to the ear. Further, in relation to the state of conversation, a case where the portable radio is held in the right hand and a case where the portable radio is held in the left hand are conceivable. Further, in order to lessen a decrease in the efficiency of radiation of the antennas induced when a radiating conductor is affected by the human body, separating the radiating conductor from the human body is desirable.

For instance, in the case of conversation performed while the portable radio is held in the right hand, the high-frequency switch 42 selects the plate conductor 32 located at a position distant from the shoulder of the human body and selects the plate conductor 30, because the portable radio is inclined at 60° in the Y direction. Therefore, a decrease in the efficiency of radiation of the antenna is reduced, and low correlation is achieved. Therefore, a transfer rate is improved, and high-capacity communication becomes feasible.

Moreover, for instance, in the case of conversation performed while the portable radio is held in the left hand, the high-frequency switch 42 selects the plate conductor 31 located at a position distant from the shoulder of the human body and selects the plate conductor 30 because the portable radio is inclined at 60° in the Y direction. Therefore, a decrease in the efficiency of radiation of the antenna is reduced, and low correlation is achieved. Therefore, a transfer rate is improved, and high-capacity communication becomes feasible.

Specifically, the angle of inclination of the portable radio is detected even in the state of conversation, and a combination of plate conductors is selected, so that low correction is achieved between the antennas. Therefore, a transfer rate is increased, and high-capacity communication becomes feasible.

Next, in relation to the configuration shown in FIG. 6, when the portable radio is inclined as shown in FIG. 4 (i.e., when the portable radio is inclined by 60° from the Z axis toward the −X direction within the coordinate system shown in FIG. 6), a correlation coefficient between the conductor plate 30 and the conductor plate 31 or a correlation coefficient between the conductor plate 30 and the conductor plate 32 comes to a value of high 0.30, and the effect of high-speed, high-capacity communication is diminished slightly. The reason for this is that, when the portable radio is inclined, a radio wave is assumed to arrive from an essentially-horizontal direction (along the X-Y plane) and, hence, the positional relationship between the conductor plate 30 and the conductor plate 31 and the positional relationship between the conductor plate 30 and the conductor plate 32 are deemed to be equal to each other when viewed from the distant field in the direction of maximum gain (i.e., the Y direction) of the conductor plate 30 and the direction of maximum gain of the conductor plate 31 or the direction of maximum gain of the conductor plate 30 and the direction of maximum gain of the conductor plate 32. In short, spatial, positional differences (phase differences) of the conductor plates become essentially equal to each other, whereby correlation is increased.

In contrast, the correlation coefficient between the plate conductors 31 and 32 comes to 0.22, thus exhibiting low correlation. The reason for this is that, when the portable radio is inclined, a radio wave is assumed to arrive from an essentially-horizontal direction (along the X-Y plane) and, hence, the position of the conductor plate 31 and the position of the conductor plate 32 are deemed to differ from each other when viewed from the distant field in the direction of maximum gain (i.e., the Y direction) of the conductor plate 31 and the direction of maximum gain of the conductor plate 32. In short, spatial, positional differences (phase differences) of the conductor plates are deemed to differ from each other, whereby correlation can be suppressed to a low level.

Therefore, in this case, the gravity sensor 22 for detecting the angle of inclination of the portable radio detects that the portable radio is inclined in the -X direction, and sends a result of detection to the control section 21. The control section 21 sends a control signal to the high-frequency switch 42 such that the duplexer 15 is connected to the matching circuit 39 of the plate conductor 31; such that the duplexer 14 is connected to the matching circuit 41 of the plate conductor 32; and such that the terminator circuit 45 is connected to the matching circuit 40 of the plate conductor 30. In this case, for instance, the impedance of the terminator circuit 45 is set to a value of 50Ω.

As a result of switching of the high-frequency switch 42 as mentioned above, the correlation coefficient between the plate conductors 31 and 32 is suppressed to a low value of 0.22. In the case of transmission, single time-space-encoded signals are transmitted at a single band from the plate conductors 31 and 32, thereby effecting spatial multiplexing. Likewise, even in the case of receiving operation, the plate conductors 31 and 32 receive the signals and separate the thus-received signals, thereby extracting information. As a result, a transfer rate is improved, and high-capacity communication becomes feasible.

As shown in, e.g., FIG. 5, the inclination of the portable radio is essentially equal to an angle achieved in an operating state where the user performs operation for creating a mail, making a connection with the Internet, or using a TV telephone while holding it in the hand at a position before the user's breast. Specifically, the angle of inclination of the portable radio is detected in the operating state, and the plate conductor 31 and the plate conductor 32 are selected, so that low correction is achieved between the antennas. Therefore, a transfer rate is increased, and high-capacity communication becomes feasible.

As described above, the characteristic feature of the portable radio of the present embodiment lies in that the plate conductor 30 is placed on the surface of the display section of the portable radio; that the two plate elements 31 and 32 are provided in parallel on the surface opposing the surface of the display section; and that antenna elements are selected in various situations where the user uses a portable cellular phone, thereby reducing a correlation coefficient between the antennas and ensuring high-speed, high-capacity communication.

Analogous advantages can be yielded even when a metal frame constituting a portion of the upper housing, a circuit board placed in the upper housing, or a plate conductor element specifically designed for use with an antenna element is used as the plate conductor 30.

The impedance of the terminator circuit is set to 50Ω, but the impedance is not limited to this value. When an antenna to be supplied with power is not affected as in the case of a reactance component of −50Ω, there is yielded an advantage of the correlation coefficient being improved by 0.05 to 0.1 or thereabouts, and the advantage of high-speed, high-capacity communication is further improved.

Although the present invention has been described in detail by reference to the specific embodiments, it is manifest to the skilled in the art that various alterations or modifications can be made to the embodiments without departing from the spirit and scope of the present invention.

The present invention is based on Japanese Application No. 2004-357318 filed on Dec. 9, 2004 in Japan, the contents of which are hereby incorporated by reference.

### INDUSTRIAL APPLICABILITY

The portable radio of the present invention can reduce a correlation coefficient among antennas in various situations where the user uses the portable radio and ensure high-speed, high-capacity communication, and hence is useful for enhancing performance of the portable radio.

1. A portable radio comprising:
a first antenna element and a second antenna element which are placed in parallel and separately from each other in a thickness direction of a housing;
a third antenna element placed in parallel and separately from the first antenna element in a widthwise direction of the housing;
a first duplexer connected to the first antenna element;
a selection unit for selecting either the second antenna element or the third antenna element and connecting the selected antenna element to a second duplexer;
a control unit for controlling the selection unit such that correlation between the first antenna element and the second or third antenna element becomes smaller;
a circuit board which is placed in the housing and has a ground pattern;
a first radio circuit section which is mounted on the circuit board and connected to the first duplexer; and
a second radio circuit section which is mounted on the circuit board and connected to the selection means.

2. A portable radio comprising:
a first housing;
a first plate conductor placed in the first housing along a long side thereof;
a second plate conductor and a third plate conductor which are placed in the first housing separately from the first plate conductor and along the long side of the housing;
a second housing;
a hinge section for pivotably joining the first housing and the second housing together;
a circuit board which is placed in the second housing and has a ground pattern;
a selection unit for selecting any one from a combination of the first plate conductor and the second plate conductor, a combination of the first plate conductor and the third plate conductor, and a combination of the second plate conductor and the third plate conductor;
a control unit for controlling the selection unit such that correlation between plate conductors of the selected combination becomes smaller;
a plurality of duplexers connected to the plate conductors of the selected combination; and
a radio circuit section which is mounted on the circuit board and connected to one of the duplexers.

3. The portable radio according to claim 1 or 2, further comprising an inclination detection unit for detecting an angle of inclination of the portable radio as the control unit for controlling the selection unit, and the selection unit is controlled in accordance with a result of detection performed by the inclination detection means.

4. The portable radio according to claim 1, wherein a radiating element which is not selected by the selection unit is short-circuited to the circuit board by way of a circuit having a certain, specific reactance component.
